(19) United States
(12) Patent Application Publication
(10) Pub. No.: US 2026/0202130 A1
(43) Pub. Date: Jul. 16, 2026

(54) Apparatus and Method for Treating Process Gas

(71) Applicant: Dürr Systems AG, Bietigheim-Bissingen (DE)

(72) Inventors: Andreas Schaefer, Wattendorf (DE); Catalina Rodriguez Correa, Mistelbach (DE); Andreas Keil, München (DE)

(21) Appl. No.: 19/135,495

(22) PCT Filed: Dec. 4, 2023
(86) PCT No.: PCT/DE2023/100938

§ 371 Date: Jun. 4, 2025

(30) Foreign Application Priority Data
Dec. 7, 2022 (DE) 10 2022 132 528.8

(51) Int. Cl. F26B 23/00; F26B 21/33; F26B 21/35; F26B 21/37

(52) U.S. Cl. CPC F26B 23/002; F26B 21/33; F26B 21/35; F26B 21/37

(57) ABSTRACT

Apparatus for treating process gas from an industrial plant, comprising a main line, a first end of the main line being connected to a process gas outlet of the industrial plant for discharging process gas to be treated from the industrial plant and a second end of the main line being connected to a process gas inlet of the industrial plant for supplying the treated process gas into the industrial plant, and an exhaust gas branch for branching off a portion of the process gas from the main line into an exhaust gas line, via which a portion of the process gas is thus dischargeable into the environment in the form of exhaust gas.

### TECHNICAL FIELD

The present invention relates to an apparatus, a method for treating process gas from an industrial plant, its use and a system.

### PRIOR ART

Process gas from industrial plants can be used as a medium in certain process steps for the manufacture of products in order to bring about certain technical effects such as drying in a process step. The industrial processes are, for example, chemical, petrochemical, pharmaceutical or solvent-processing processes. The industrial plants are, for example, workpiece processing systems, e.g., for drying and/or hardening painted and/or coated and/or bonded workpieces (e.g., car bodies or body parts, electrodes, membranes, lithium-ion batteries, etc.). In order to improve the technical effect of the process gas in a process step, the process gas can be treated accordingly before use, for example to adjust the temperature and/or the humidity of the process gas for the process step.

Conventional apparatuses for treating process gas often contain a capacitor, which cools and/or heats a large proportion of the process gas. In a cooling process, for example, warm and humid air can be cooled by condensation and the humidity of the process gas can be reduced. In particular, the temperature of the process gas after the cooling process can be lower than before. The process gas is therefore preferably additionally heated after the cooling process in order to improve the drying properties of the process gas. However, the use of such a capacitor with a subsequent heating system can result in comparatively high operating and acquisition costs and at the same time have a disadvantageous energy balance.

### SUMMARY OF INVENTION

It is a task of the invention to create an improved system for the treatment of process gas from an industrial plant/process, which is economically advantageous and also ensures good treatment of the process gas while avoiding overly complex constructions. In particular, it is the task of the invention to improve the treatment of the process gas of an industrial drying plant, preferably a plant for drying electrodes, preferably anodes, for capacitors, ultracapacitors or batteries, preferably lithium-or sodium-based batteries, which are produced or obtained using a solvent-based application process. Preferably, the solvent can be water. Preferably, the task of the invention is to be able to supply or provide the process gas to the drying system with properties that are as favorable and/or stable as possible, in particular properties that are at least virtually independent of environmental conditions.

According to the invention, this task is solved with an apparatus for treating process gas from an industrial plant of claim 1. The apparatus comprises a main line, a first end of the main line being connected to a process gas outlet of the industrial plant for discharging process gas to be treated from the industrial plant and a second end of the main line being connected to a process gas inlet of the industrial plant for supplying the treated process gas into the industrial plant; and an exhaust gas branch for branching off a portion of the process gas from the main line into an exhaust gas line, via which a portion of the process gas is thus dischargeable into the environment in the form of exhaust gas.

The inventors have found that it can be advantageous for the treatment of process gas to branch off a portion of the process gas into an exhaust gas line for discharge into the environment and to supply the rest back into the industrial plant via the process gas inlet. Typically, the process gas discharged from the industrial plant has a high temperature and high humidity. By branching off a portion of the hot and humid process gas, the volume flow in the main line is reduced after branching. The amount of water contained in the process gas per time unit is reduced accordingly. As the volume flow discharged through the process gas outlet is greater than the volume flow supplied through the process gas inlet, the difference can be compensated for in particular by air flows from the environment, which flow into the industrial plant separately from the main line. In particular, the air flows from the environment may be cooler and have a lower absolute humidity than the process gas in the main line. By admixing ambient air directly into the industrial plant, the relative humidity of the process gas can be reduced, the ability to absorb humidity can be increased and, in particular, the drying properties of the process gas can be improved. By branching off a portion of the process gas from the main line and thereby treating the process gas, the apparatus can be kept technically simple and, in particular, space-saving. The use of operating fluids such as refrigerants or cooling water to treat the process gas can therefore be dispensed with.

Humidity is preferably to be understood as absolute humidity, e.g., absolute air humidity, wherein relative humidity can be calculated using other gas parameters. Absolute humidity is the mass of water vapor contained in a given volume. At a certain temperature, for example, there is a maximum absolute humidity and the air can no longer absorb any more moisture in this state. The relative humidity expresses the ratio between the absolute humidity and the maximum humidity.

In the context of this disclosure, “one” is to be read as an indefinite article and thus always also as “at least one”, unless expressly stated otherwise. A volume flow naturally also refers to a mass flow, wherein the density can be variable. However, in specifying the volume flow, it is preferred that the density is assumed to be a constant when describing and comparing the volume flow. In this case, the volume flow is therefore proportional to the mass flow. Directional information such as “behind” (nach) and/or “in front of” (vor) generally refers to the direction of flow. For example, the phrase “behind the unit” and/or “in front of the unit” should be understood as “downstream of the unit” and/or “upstream of the unit”. The “adjustment” of a gas parameter, for example a temperature, is to be understood in particular as both direct and indirect controlled manipulation of the gas parameter. A gas parameter can be adjusted to increase, decrease or hold at any level. In particular, the adjusting can generally involve regulation or control.

In one preferred embodiment, the apparatus comprises a fresh gas line arranged downstream of the exhaust gas branch,, through which fresh gas, preferably air from the environment, is suppliable to the main line. Furthermore, the apparatus has a mixer for mixing fresh gas from the fresh gas line with the process gas conducted in the main line, wherein the mixer is arranged upstream of the process gas inlet of the industrial plant. In particular, the fresh gas line can be arranged downstream of the exhaust gas branch of the main line, with fresh gas being supplied to the main line after the portion of the process gas from the main line is branched off into the exhaust gas line at the exhaust gas branch.

The fresh gas line arranged downstream of the exhaust gas branch can preferably be used to supply air from the environment of the main line. The volume flow of the process gas in the main line downstream of the fresh gas line can be increased. Preferably, the volume flow of the process gas downstream of the fresh gas line can be aligned with a volume flow of the process gas through the process gas outlet of the industrial plant. It is particularly preferable if the volume flow can be adjusted in such a way that a predetermined negative pressure is or can be ensured or adjusted in the industrial plant, in particular in its areas conducting the process gas, compared to an air pressure in the environment of the plant. In particular, the (natural) gas property of the fresh gas from the environment can be used to adjust a gas parameter of the process gas. Relevant gas parameters can be temperature, pressure, chemical composition, partial pressures, dew points and/or humidity. For example, if the temperature of the fresh gas is cooler than the process gas at the outlet from the industrial plant, the temperature of the process gas can be lowered after the fresh gas has been supplied and thus adjusted at the same time. If the ambient air also or alternatively has a lower humidity than the process gas at the outlet from the industrial plant, the humidity of the process gas in the main line can be lowered and adjusted after fresh gas has been supplied, for example. This allows the supply of fresh gas to have a positive effect on the drying properties of the process gas. In particular, the process gas can already be conditioned in the main line by supplying fresh gas before the process gas is supplied to the industrial plant. With the mixer for mixing fresh gas with the process gas, a process gas flow with homogeneous gas properties can be formed in the main line, in particular a process gas flow with a uniform temperature profile across the flow cross-section.

In particular, the mixer can comprise a chamber with at least one respective inlet for the fresh and process gas and an outlet, wherein the respective gas jet/stream can flow into the chamber with different flow directions, for example, and the fresh gas can mix with the process gas before the now mixed flow is discharged from the chamber into the main line.

The mixer can also be a simple pipe section of the main line to which the fresh gas line is connected. In particular, the cross-section of the mixer can be configured to be variable in the direction of flow in order to adjust an advantageous flow velocity. For example, the mixer can have an increasing cross-section in the area of the incoming fresh gas jet/flow in the direction of flow of the main line in order to achieve a constant flow velocity when exiting the mixer. The mixer can also have a cross-section that narrows in the direction of flow, for example to achieve a higher flow velocity when exiting the mixer. It is particularly advantageous to minimize the pressure loss through the mixer and at the same time achieve a flow with uniform gas properties, i.e., a homogeneous flow.

In particular, the mixer can also have fixtures for generating a turbulent flow, for example fins, blades or vortex generators in general, in order to implement a homogeneous flow with a compact design at the same time. At least parts of the fixtures can be configured as passive or active, in particular actively driven, components in order to promote or ensure the desired mixing of the gas jets/flows.

In a further preferred embodiment, the apparatus comprises a fresh gas line arranged downstream of the exhaust gas branch, through which fresh gas, preferably air from the environment, is suppliable to the main line. Further, the apparatus comprises a unit for conditioning the fresh gas, wherein a gas parameter of the fresh gas, in particular a humidity, is adjustable. Thus, a gas parameter of the process gas, in particular a temperature and/or a humidity, is adjustable by means of the admixture of the fresh gas. Preferably, the unit can also reduce the humidity of the fresh gas by extracting water vapor from the fresh gas. After the fresh gas has been dehumidified, the fresh gas is preferably supplied into the main line. By admixing additional dehumidified fresh gas, the humidity of the process gas in the main line can be further reduced and/or adjusted more precisely. This would have the advantage that the humidity of the process gas in the main line can be adjusted over a larger humidity range, especially if the humidity of the ambient air serving as fresh gas changes. In particular, the unit can be a capacitor, wherein the fresh gas is cooled to such an extent that water can be condensed out of the gas and discharged.

Conditioning can be, in particular, humidification or dehumidification and/or heating or cooling. The unit can therefore be a humidifier or dehumidifier. In particular, water can be injected or atomized into the process gas during conditioning. The unit can also be an electric heater or a heat exchanger (often referred to as a heat transmitter), for example. If the unit is a heat exchanger or if the unit comprises such a heat exchanger, this can be designed—without being exhaustive—for example as a gas-gas heat exchanger, in particular as a cross co-current or cross counter-current heat exchanger, but also as a regenerative heat accumulator, in particular a thermal wheel, preferably a rotating thermal wheel (often also referred to as a rotary heat transmitter). In a design as a thermal wheel, thermal energy from a first gas flow is temporarily stored on a receiving side in a heat storage element, in particular a heat storage mass, which is then moved towards a discharge side, where the temporarily stored thermal energy is at least partially released to a second gas flow, e.g., process gas and/or the fresh gas.

Optionally or additionally, it can also be advantageous if a unit is provided downstream of the exhaust gas branch for conditioning the process gas remaining in the main line after the exhaust gas branch. This unit can preferably be arranged upstream of a fresh gas supply into the main line. Preferably, this unit is a humidifier and/or dehumidifier in order to advantageously adjust the humidity of the process gas to a favorable range before the fresh gas is supplied. However, in further advantageous embodiments, the unit may also comprise, include or consist of a heating and/or cooling element, a compression unit, an expansion stage, a demister and/or an ionization apparatus. This unit can be used to adjust at least one gas parameter, for example humidity, temperature, pressure and/or droplet/particle loading of the process gas, to a favorable value and/or range of values before fresh gas is supplied.

In the context of the invention, a favorable value or value range of a gas parameter is understood in particular to mean a value or value range at which the process gas can or does perform its task in the industrial plant well, preferably almost optimally. For process gas in industrial drying systems in particular, these would be values of the gas parameter(s) at which the process gas in the drying system can effectively and efficiently absorb emissions from the material to be dried and remove them from a drying chamber in the drying system.

The adjustment of a gas parameter, for example a temperature, can in particular also influence other gas parameters associated with the gas, for example humidity or pressure. The adjustment of a gas parameter can therefore also include the adjustment of any number of gas parameters, in particular related gas parameters.

In a further preferred embodiment, the apparatus has a first bypass line, through which fresh gas is conducted past an aggregate for conditioning the fresh gas, and/or a first adjuster, wherein the first adjuster adjusts a respective volume flow in the first bypass line and/or through the unit. In particular, a portion of the fresh gas that comes from the environment and can be supplied to the main line can be conducted past the unit for conditioning the fresh gas parallel to the fresh gas line. In such an embodiment, a branching point can be arranged upstream of the unit and thus divide the fresh gas into two streams, with one portion of the fresh gas being supplied to the unit and another portion of the fresh gas being conducted past the unit.

As a portion of the fresh gas is conducted past the unit, there is no need to condition this portion of the fresh gas through the unit. This means that the quantity of conditioned fresh gas can be reduced and/or adjusted, even if the unit is operated at an unchanged capacity. In the preferred case in which the unit is a dehumidifier, for example, less water vapor can be extracted from the fresh gas with the same dehumidification power of the unit by conducting a portion of the fresh gas in the first bypass line past the dehumidifier. This enables, for example, a precise and/or faster adjustment of a desired humidity of the fresh gas, especially if the dehumidification capacity cannot be increased or decreased quickly and/or precisely controlled.

In particular, the unit and the first bypass line can be arranged in a conditioning unit, preferably in a housing. Within the conditioning unit, for example, a portion of the fresh gas can be conducted past a dehumidifier via the first bypass line. The conditioning unit can also be understood as a dehumidifier with integrated bypass. In particular, the first bypass line can be a flow channel, which can be integrated into the housing of the conditioning unit, for example.

The first adjuster can optionally have the following: a first control unit, a first flap for adjusting a respective volume flow, a first sensor for measuring a gas parameter, in particular a humidity, wherein the first sensor is arranged upstream of the unit for conditioning the fresh gas and transmits gas parameter data to the first control unit, which uses the transmitted data for adjusting the flap.

For the purposes of this description, the transmission of data, in particular measurement data, by, for example, a sensor such as the first sensor, should be understood to mean not only the active transmission of data but also the provision of data for retrieval. Transmission and/or retrieval of data can be implemented by means of wired, in particular wire-bound, but also wireless communication between the sensor and a unit receiving the data (for example the first control unit). For the purposes of this description, wired transmission also includes optical, fiber optic-based transmission in addition to analog or digital electrical communication. While a wireless transmission can also include or represent an optical or acoustic transmission of data in addition to a radio transmission.

In particular, the first flap can be part of a first flap system, which can comprise several flaps. The first flap itself can also be understood as a flap system. It is also conceivable that the first flap could be designed as a multi-part flap. Preferably, a further flap is arranged in the first bypass line, wherein a flap is arranged in a parallel fresh gas line. The first flap can, for example, be a control flap or a chamber for splitting gas flows, which is arranged at an interface between the fresh gas line and the second bypass line. Alternatively, at least individual flaps can also be designed as slides, apertures or valves, without this changing the overall function of the adjuster within the scope of the present invention. The term “flap” can therefore also be generally understood as an apparatus and/or element for flow control.

In particular, the first sensor can comprise several sensors that are part of a sensor system, for example. The first sensor can be a humidity or temperature sensor, for example, which can measure the humidity and/or temperature of the fresh gas supplied to the unit. A sensor system forming the first sensor can also include a humidity, pressure and/or temperature sensor. It may also be advantageous that a unit or device or sensor for sensing a chemical composition or at least the proportion of at least one chemical component is provided in the first sensor and/or corresponding sensor system. The first sensor can also be arranged downstream of the unit in the fresh gas line or in the first bypass line.

In particular, the first control unit can be and/or comprise a computer and/or a computer program for adjusting the first flap on the basis of the transmitted gas parameter data. In particular, adjusting a flap can involve regulating and/or controlling it.

In a further preferred embodiment or development, the apparatus comprises a fresh gas line arranged downstream of the exhaust gas branch, through which fresh gas, preferably air from the environment, is suppliable to the main line. Further, the apparatus comprises a heat exchanger for adjusting a gas parameter of the fresh gas, in particular a temperature, wherein a gas parameter of the process gas, in particular a temperature and/or humidity, is adjustable by means of the admixture of the fresh gas.

Preferably, the heat exchanger is associated with the fresh gas line, with the fresh gas being supplied from the fresh gas line to the heat exchanger. The heat exchanger is particularly preferably arranged downstream of a unit for conditioning the fresh gas, i.e., it is connected downstream of the unit for conditioning the fresh gas, wherein the unit is in particular a dehumidifier. The heat exchanger can transfer thermal energy to the fresh gas flowing through it, wherein a higher temperature of the fresh gas can be adjusted downstream of the heat exchanger.

In another or supplementary embodiment, the heat exchanger is preferably associated with the fresh gas line, wherein the fresh gas is already tempered by the heat exchanger before it is supplied to the process gas. In particular, a higher process gas temperature can be adjusted by adding fresh gas. Alternatively, the heat exchanger can be associated with the main line, wherein the process gas is already admixed with fresh gas before the process gas admixed with fresh gas is tempered by the heat exchanger arranged in the main line.

In a further preferred embodiment, the apparatus has a second bypass line, through which fresh gas, preferably from the environment, is conducted past the heat exchanger, and/or a second adjuster, wherein the second adjuster adjusts a respective volume flow in the second bypass line and/or through the heat exchanger. In particular, a portion of the fresh gas that comes from the environment and can be supplied into the main line can be conducted past the heat exchanger parallel to the fresh gas line. In such an embodiment, a branching point can be arranged upstream of the heat exchanger and thus divide the fresh gas into two streams, with one portion of the fresh gas being supplied to the heat exchanger and another portion of the fresh gas being conducted past the heat exchanger.

The second adjuster can adjust the volume flow of the fresh gas through a parallel fresh gas line and thus through the heat exchanger and/or through the second bypass line. Preferably, the second adjuster is arranged downstream of a unit, in particular a dehumidifier, for conditioning the fresh gas. As a portion of the fresh gas is conducted past the heat exchanger, a portion of the fresh gas is not tempered by the heat exchanger. This means that the fresh gas can be heated less overall, as a portion of the fresh gas is conducted past the heat exchanger using the second bypass line. This makes it possible, for example, to adjust the desired temperature of the fresh gas. With an electric radiator, for example, the heating capacity can be increased and/or reduced. In such a case, the second bypass line can be dispensed with if necessary. An electric heater or electric heating element (e.g. an IR emitter, a ceramic heating element, resistance heating element, etc.) combined with a heat exchanger would also be conceivable in order to be able to control the temperature of the fresh gas over an even wider temperature range.

In particular, the heat exchanger and the second bypass line can be arranged in a heat exchanger unit, especially in a housing. Within the heat exchanger unit, for example, a portion of the fresh gas can be conducted past the heat exchanger via the second bypass line. The heat exchanger unit can therefore also be understood as a heat exchanger with integrated bypass. In particular, the first bypass line can be a flow channel, which can be integrated into the housing of the heat exchanger unit, for example. In a heat exchanger unit, for example, a plurality of individual heat exchangers and a plurality of second bypass lines can be arranged, which can be arranged adjacent to each other, for example in series or parallel with regard to the main flow direction.

The second adjuster can optionally also have the following: a second control unit, a second flap for adjusting a respective volume flow, a second sensor for measuring a gas parameter, in particular a temperature,
wherein the second sensor is arranged in the main line and transmits gas parameter data to the second control unit, which adjusts the second flap on the basis of the transmitted data.

The above remarks on the first flap can apply analogously to the second flap. The second flap can therefore also be part of a second flap system, which can comprise several flaps. Preferably, a second flap is arranged in a fresh gas line routed parallel to the second bypass line and a further second flap is arranged in the second bypass line. The second flap can, for example, be a control flap or a chamber for splitting gas flows, which is arranged at an interface between the fresh gas line and the second bypass line.

In particular, the second sensor can comprise several sensors that are part of a sensor system, for example. The second sensor can be a humidity or temperature sensor, for example, which can measure the humidity and/or temperature of the process gas in the main line. A sensor system forming the second sensor can also include a humidity, pressure and/or temperature sensor. It may also be advantageous that a unit or device or sensor for sensing a chemical composition or at least the proportion of at least one chemical component is provided in the second sensor and/or corresponding sensor system. The second sensor is preferably arranged downstream of the heat exchanger and can particularly preferably measure the temperature of the process gas in the main line after the fresh gas is supplied to the process gas. The second sensor can also be located upstream of the heat exchanger or in the second bypass line. In particular, the second control unit can be a computer and/or a computer program for adjusting the second flap using the transmitted gas parameter data.

In a further preferred embodiment, the apparatus comprises a fresh gas line arranged downstream of the exhaust gas branch, through which fresh gas, preferably air from the environment, is suppliable to the main line, wherein a heat exchanger is provided for extracting thermal energy from the exhaust gas, wherein at least a portion of the extracted thermal energy is transferable to the fresh gas in the fresh gas line and/or to the process gas in the main line downstream of the exhaust gas branch.

Preferably, the heat exchanger is associated with the exhaust gas line, with the exhaust gas being routed to the heat exchanger after branching off. The heat exchanger can be an air-to-air heat exchanger and/or a cross-flow heat exchanger, wherein the thermal energy is transferred from the exhaust gas flow to the fresh gas, which flows through the heat exchanger at the same time. In particular, the thermal energy can be transferred indirectly to the process gas in the main line, for example by admixing the fresh gas in the main line. It is also conceivable to transfer the thermal energy from the exhaust gas directly to the process gas by supplying part of the process gas to the heat exchanger. Alternatively, a respective heat exchanger can be arranged in the fresh gas line and in the main line, wherein thermal energy is transferred from the exhaust gas flow to the fresh gas and to the process gas by means of the respective heat exchanger.

In particular, thin part of the exhaust gas is conducted to the heat exchanger in a line that is connected to the exhaust gas line. After flowing through the heat exchanger, the exhaust gas can be returned to the exhaust gas line.

Optionally, a portion of the thermal energy extracted from the exhaust gas can be supplied to another industrial process, in particular the industrial plant. For example, the heat exchanger may have an additional heat transfer line, i.e., an additional pipe system or channel for the passage of a heat transfer medium suitable for the industrial process, a branch for discharging a portion of a heat transfer medium flowing through the heat exchanger for provision to the industrial process and/or a further, additional heat exchanger for the decoupling of thermal energy for provision to the industrial process.

The use of the heat exchanger associated with the exhaust gas line can be advantageous in terms of energy, as thermal energy is extracted from the exhaust gas that would otherwise be released into the environment as heat loss and this energy is supplied back into the process gas instead.

In a further preferred embodiment, the apparatus has a third adjuster for adjusting a volume flow in the exhaust gas line, in particular an exhaust gas blower associated with the exhaust gas line, wherein a gas parameter of the process gas, in particular a humidity, is adjustable as a function of the volume flow adjusted in the exhaust gas line.

Preferably, the third adjuster is or comprises an exhaust gas blower, which is arranged in the exhaust gas line. The exhaust gas blower can be used to adjust the volume flow, for example via a blower characteristic curve in the exhaust gas line. According to the invention, a humidity of the process gas can preferably be adjusted as a function of the volume flow adjusted in the exhaust gas line. For example, it may be necessary to branch off more process gas through the exhaust gas blower so that the humidity of the process gas in the main line downstream of the fresh gas line remains low.

In particular, the third adjuster can alternatively or additionally have a flap at the exhaust gas branch or following it downstream of the exhaust gas line, for example, a regulating and/or control flap, wherein a volume flow in the exhaust gas line can be adjusted by altering the flap. The flap allows the adjustment or regulation of a volume flow from the process gas of the main line that is discharged as exhaust gas at the exhaust gas branch. The flap can also be designed as a single or multi-stage flap system. Instead of this at least one flap, an aperture, a blade flap or a valve, in particular a gas valve, can also be used.

The third adjuster can optionally have the following: a third control unit, a third flap for adjusting a respective volume flow, a third sensor for measuring a gas parameter, in particular a humidity, wherein the third sensor is arranged upstream of the unit for conditioning the fresh gas and transmits gas parameter data to the third control unit or makes it available to it, which uses the transmitted data for adjusting the flap. Alternatively or additionally, the third sensor can also transmit the data determined during measurement to the first and/or second control unit or make it available to them.

In particular, the third flap can be part of a third flap system, which can comprise several flaps. The third flap itself can also be understood as a flap system. It is also conceivable that the third flap could be designed as a multi-part flap. Preferably, a further flap is arranged in a third bypass line, wherein a flap is arranged in a parallel exhaust gas line. The third flap can, for example, be a control flap or a chamber for splitting gas flows, which is arranged at an interface between the exhaust gas line and the second bypass line. Alternatively, at least individual flaps can also be designed as slides, apertures or valves, without this changing the overall function of the adjuster within the scope of the present invention. The term “flap” can therefore also be generally understood as an apparatus and/or element for flow control.

In particular, the third sensor can comprise a plurality of sensors that are part of a sensor system, for example. The third sensor can be a humidity or temperature sensor, for example, which can measure the humidity and/or temperature of the fresh gas supplied to the unit. A sensor system forming the third sensor can also include a humidity, pressure and/or temperature sensor. It may also be advantageous that a unit or device or sensor for sensing a chemical composition or at least the proportion of at least one chemical component is provided in the third sensor and/or corresponding sensor system. The third sensor can also be arranged downstream of the unit in the exhaust gas line or in the third bypass line.

In particular, the third control unit can be and/or comprise a computer and/or a computer program for adjusting the first flap on the basis of the transmitted gas parameter data. In particular, adjusting a flap can involve regulating and/or controlling it.

The present invention is also based on the task of providing an improved method for treating process gas from an industrial plant.

According to the invention, this task is solved by a method for treating at least a portion of process gas which is discharged from an industrial process, wherein the method comprises the following method steps: Discharging the process gas to be treated from an industrial process into a main line and supplying the treated process gas from the main line into the industrial plant; and branching off a portion of the process gas from the main line into an exhaust line at an exhaust branch, via which a portion of the process gas is discharged to the environment in the form of exhaust gas. The treatment of process gas can involve branching off process gas. The volume flow of the process gas supplied to the industrial process can therefore be reduced in comparison to the process gas discharged from the industrial process as a result of the treatment. In particular, the industrial process can include a start of operation and an end of operation of an industrial process plant, for example the heating phase and/or cooling phase of a drying apparatus.

With this method according to the invention, the same advantages can be achieved as with the apparatus described above. With regard to the advantages and advantageous/preferred embodiments, reference is therefore also made to the above explanations in connection with the apparatus according to the invention.

In a preferred embodiment of the invention, the method comprises supplying fresh gas, preferably air from the environment, into the main line via a fresh gas line. The fresh gas line flows into the main line downstream of the exhaust gas branch, wherein the fresh gas supplied compensates for the exhaust gas discharged. Here, a gas parameter of the process gas, in particular a temperature and/or a humidity, is adjusted by means of the admixture of the fresh gas. In particular, the volume flow of the process gas in the main line can be greater after the supply of fresh gas than before the supply.

In a further preferred embodiment, the fresh gas is mixed with the process gas associated with the main line as it is supplied into the main line, with the respective gas flows being mixed together before the treated process gas is conducted to the industrial process. Alternatively, the gas flows, i.e., the fresh gas flow and the process gas flow, can be mixed further downstream of the main line before the process gas is conducted to the industrial process. It is particularly preferred that the process gas is mixed before the process gas is heated in the industrial plant in a further method step.

In a further preferred embodiment, fresh gas, preferably air from the environment, is supplied to the main line via a fresh gas line arranged downstream of the exhaust gas branch. Further, it is conditioned, wherein a gas parameter of the fresh gas, in particular a humidity, is adjusted, wherein a gas parameter of the process gas, in particular a temperature and/or humidity, is adjusted by means of the admixture of the fresh gas.

In a further preferred embodiment, fresh gas, preferably air from the environment, is supplied to the main line via a fresh gas line arranged downstream of the exhaust gas branch. In addition, a portion of the fresh gas is conducted past a unit for conditioning the fresh gas and a respective volume flow is adjusted, with the first adjuster adjusting the respective volume flow as a function of a gas parameter, in particular a humidity, which is measured before the fresh gas is conditioned.

In a further preferred embodiment, fresh gas, preferably air from the environment, is supplied to the main line via a fresh gas line arranged downstream of the exhaust gas branch. Further, a gas parameter of the fresh gas, in particular a temperature, is adjusted in a heat exchanger before it is supplied into the main line, wherein a gas parameter of the process gas, in particular a temperature and/or a humidity, is adjusted by means of the admixture of the fresh gas.

In a further preferred embodiment, fresh gas, preferably air from the environment, is supplied to the main line via a fresh gas line arranged downstream of the exhaust gas branch. Further, a portion of the fresh gas is supplied into a second bypass line past a heat exchanger for heating the fresh gas and a respective volume flow is adjusted through the heat exchanger and/or through the second bypass line by means of a second adjuster, wherein the second adjuster adjusts the respective volume flow as a function of a gas parameter of the process gas, in particular a temperature.

In a further preferred embodiment, fresh gas, preferably air from the environment, is supplied to the main line via a fresh gas line arranged downstream of the exhaust gas branch. Further, thermal energy is extracted from the exhaust gas conducted through the exhaust gas line in a heat exchanger, at least a portion of the thermal energy extracted from the exhaust gas being transferred to the fresh gas in the fresh gas line and/or process gas in the main line.

In a further preferred embodiment, a branched-off volume flow in the exhaust gas line is adjusted by means of a third adjuster, in particular an exhaust gas blower associated with the exhaust gas line, wherein a gas parameter of the process gas, in particular a humidity, is adjusted as a function of the volume flow adjusted in the exhaust gas line.

In a further optionally preferred embodiment, the following method steps are also carried out to start operation of the process gas treatment: a determination, in particular by means of a measurement (preferably by interrogating or reading out at least one sensor, particularly preferably by regularly recurring or continuous interrogation of a sensor, wherein the interrogation/readout in the sense of the inventors also comprises an active provision of measured values by the sensor), of the humidity of a fresh gas, preferably air from the environment, before entry into the fresh gas line, wherein the fresh gas is humidified and/or dehumidified as a function of the measured humidity of the fresh gas before the fresh gas is supplied to the main line. The measured humidity is preferably adjusted in relation to or compared with a target humidity or a target humidity interval. The humidity of the fresh gas determined before it enters the fresh gas line can correspond in particular to an ambient humidity. In the event of a high ambient humidity, i.e., a humidity that exceeds a target humidity and/or a target humidity interval for the fresh gas to be supplied to the process gas, the fresh gas is preferably dehumidified before the fresh gas is supplied to the main line. The target humidity and/or the target humidity interval for the fresh gas to be supplied to the process gas can in particular depend on, be influenced, controlled and/or regulated by a humidity and/or another gas parameter (e.g., temperature and/or pressure) of the process gas when it enters the main line and/or upstream of a supply of fresh gas to the process gas via the fresh gas line and/or when it exits the main line and/or downstream of a supply of fresh gas to the process gas via the fresh gas line. The ambient humidity can also be determined indirectly by measuring other air parameters such as pressure or temperature. It is also conceivable to transmit the ambient humidity from an external data source. The ambient humidity may also have a low value, i.e., the humidity falls below the target humidity and/or the target humidity interval for the fresh gas to be supplied to the process gas. In this case, the fresh gas is preferably humidified before the fresh gas is supplied into the main line. The process gas treatment can be started, for example, after maintenance or other downtime of the system.

In a further preferred embodiment, the following is carried out at the end of operation of the process gas treatment: Branching-off a portion of the process gas at an exhaust gas branch from the main line into an exhaust gas line, via which a portion of the process gas is discharged into the environment in the form of exhaust gas, more than 50% of the process gas being transferred into the exhaust gas line; supplying fresh gas, preferably air from the environment, into the main line via a fresh gas line arranged downstream of the exhaust gas branch, a volume flow of the supplied fresh gas preferably corresponding to the exhaust gas volume flow. Although it may be possible to return some of the process gas from the industrial process to the industrial process, it is preferable that the amount of fresh gas supplied to the industrial process is significantly greater than the returned process gas. Preferably, at the end of operation, the industrial process is completely supplied with air from the environment, i.e., the process gas quantity discharged from the industrial process is completely branched off into the exhaust gas line and discharged into the environment as exhaust air. The method according to the invention can be advantageous in order to avoid the formation of condensation.

In a further preferred embodiment, the treated process gas is further tempered with additional heat in a further method step before a product to be dried is acted upon by the process gas. Preferably, the treated process gas is fed into the industrial plant for a drying process, wherein the process gas is heated in the industrial plant in a further method step. In particular, additional heat can be generated in the method step by burning a fuel such as natural gas in a heating unit and transferring the resulting additional heat to the process gas via a further heat exchanger. Alternatively, the additional heat in the further method step can also be provided by an electric heater. The process gas can then be supplied to a drying process in order to absorb moisture from the goods to be dried.

Optionally, the industrial plant can have a drying system with several drying modules, wherein the treated process gas is divided between the drying modules and a respective heating unit is arranged in each drying module, by means of which additional heat is added to the process gas. After the process gas is heated by the respective heating unit, the goods to be dried can be acted upon by the process gas. Splitting the process gas into several drying modules can improve the drying result.

In principle, the invention can be used for any industrial plant and industrial processes that use process gas. The applications given above as examples of the technical background also apply to the apparatuses and methods according to the invention. Advantageously, the apparatus according to the invention and the method according to the invention can be used for treating a process gas of a dryer, in particular in a production plant for manufacturing an electrical current storage device, which is discharged from a drying plant in which electrodes are dried after a coating process.

Preferably, the invention is used in the coating of electrodes for lithium-ion accumulators, where water is used as the solvent.

### Example Embodiments

The invention is explained in more detail below with reference to several embodiments. Furthermore, it is made clear that the problem-solving proposals according to the invention can be applied to various different industrial processes.

### FIGURE LIST

In the drawings:

FIG. 1 is a schematic representation of an apparatus according to the invention for treating process gas from an industrial plant for drying an electrode coating;

FIG. 1a is a schematic representation of a method according to the invention of FIG. 1 for the treatment of process gas from an industrial plant;

FIG. 2 is a schematic representation of a further apparatus according to the invention with a fresh gas supply for treating process gas from an industrial plant for drying an electrode coating;

FIG. 2a is a schematic representation of a method according to the invention of FIG. 2 with fresh gas supply for the treatment of process gas from an industrial plant;

FIG. 3 is a schematic representation of a further apparatus according to the invention with adjusters for treating process gas from an industrial plant;

FIG. 3a is a schematic representation of a method according to the invention of FIG. 3 for treating process gas from an industrial plant;

FIG. 4 is a schematic representation of an alternative device according to the invention with adjusters for the treatment of process gas from an industrial plant;

FIG. 4a is a schematic representation of a method according to the invention of FIG. 4 for treating process gas from an industrial plant;

FIG. 5 is a schematic representation of an alternative apparatus according to the invention with adjusters for treating process gas from an industrial plant;

FIG. 5a is a schematic representation of a method according to the invention of FIG. 5 for treating process gas from an industrial plant;

FIG. 6 is a schematic representation of a drying module for treating process gas from an industrial plant;

FIG. 7 is a schematic representation of a control method of the first adjuster;

FIG. 8 is a schematic representation of a control method of the second adjuster; and

FIG. 9 is a schematic representation of a control method of the third adjuster;

FIG. 10 is a schematic representation of a further apparatus according to the invention with adjusters for the treatment of process gas from an industrial plant similar to FIG. 2 but with a thermal wheel;

FIG. 11 is a schematic representation of a further apparatus according to the invention with adjusters for the treatment of process gas from an industrial plant with an alternative arrangement of a thermal wheel;

FIG. 11a is a schematic representation of a process according to the invention of FIG. 11 with fresh gas supply for the treatment of process gas from an industrial plant;

FIG. 12 is a schematic representation of a further apparatus according to the invention with fresh gas supply for the treatment of process gas from an industrial plant for drying an electrode coating;

FIG. 12a is a schematic representation of a process according to the invention of FIG. 12 with fresh gas supply for the treatment of process gas from an industrial plant.

### PREFERRED EMBODIMENT OF THE INVENTION

In the industrial production of electrodes for lithium-ion batteries and the like, a wet coating in the form of a slurry or paste-can be applied to at least one side of a carrier material. An electrically conductive, flat substrate, in particular a conductive and/or metallic foil, is preferably used as the carrier material. The wet coating preferably has components of fine powders mixed with a solvent. Water in particular can be considered as a solvent. According to the invention, this takes place in an industrial process, which in the example shown is or comprises a drying process and is carried out on an industrial scale in an industrial plant 2. In these cases, a wet coating is applied continuously or discontinuously to a moving carrier substrate and dried in an oven or dryer. The water is removed during the drying process, which solidifies the applied coating. In typical cases where both sides of the foil are to be coated in succession, for example, a first coating is applied continuously to a moving carrier substrate and dried in an oven or dryer, followed by the application of a second wet coating, which is then dried in a second drying step.

In a particularly preferred embodiment for the production of battery electrodes, the wet coating is applied to both sides of the carrier material and then dried in an oven or dryer. This arrangement is referred to as concurrent/simultaneous double-sided coating and drying. In the case of the production of lithium ion electrodes, this arrangement is particularly advantageous in terms of increasing productivity, as it only requires one drying step after the wet coating slurry has been applied to both sides. In addition, the drying result can be improved due to a more uniform heat input on both sides of the coating, in particular it can be made more uniform, as each side is advantageously only subjected to one drying step.

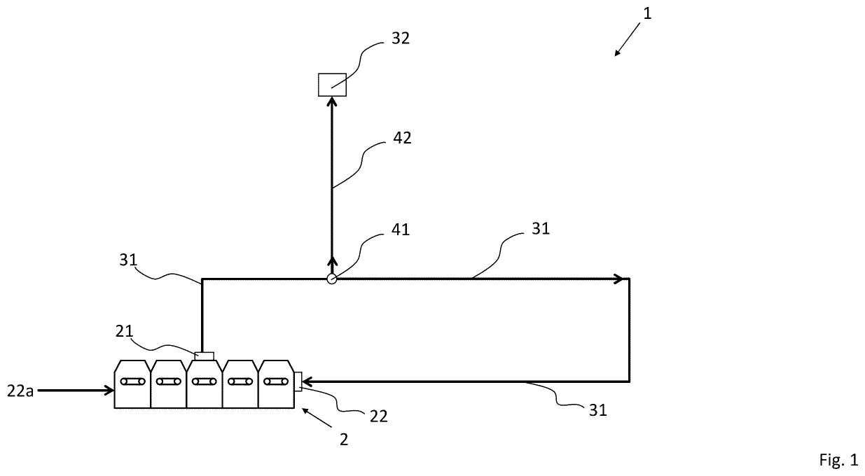

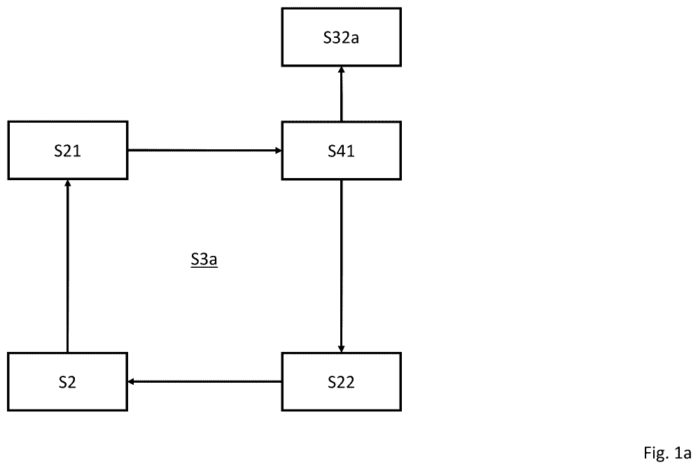

Referring to FIG. 1, a first preferred embodiment of an apparatus according to the invention for treating process gas from an industrial plant 2 is described by way of example.

In the industrial plant 2, water is absorbed from the surface of the wet coating by means of a process gas. In particular, the water from the wet coating that serves as a solvent is converted into a vapor phase, for example by introducing thermal energy, so that the resulting vapor is and/or can be absorbed by the process gas that surrounds or flows around the coated foil. The process gas is then transported out of the industrial plant 2 via a process gas outlet 21. A first end of a main line 31 is connected to the process gas outlet 21 to receive the process gas from the industrial plant 2. A second end 22 of the main line 31 is connected to a process gas inlet 22 of the industrial plant 2 to introduce the treated process gas into the industrial plant 2. The process gas can be conveyed downstream and/or upstream of the industrial plant 2 through the main line 31 by means of one or more non-shown blowers. In particular, the apparatus can set a negative pressure compared to the environment in the industrial plant 2. A portion of the process gas is branched off from the main line 31 at an exhaust gas branch 41 into an exhaust gas line 42 downstream of the process gas inlet 22 and discharged as exhaust gas into the environment 32 or fed to at least one cleaning, treatment and/or further treatment apparatus. Due to the negative pressure prevailing in the industrial plant 2, ambient air 32 can flow into the industrial plant 2 via further inlets arranged on the housing of the industrial plant 2, here exemplified as ambient air inlet 22a. Such inlets can be arranged in particular where the foil to be coated is introduced into and/or discharged from the industrial plant. Such openings are typically called “web slots”.

Typically, the process gas discharged from the industrial plant has a temperature of around 120° C. and a humidity of around 35 g per kg of dry air, for example. The volume flow of the discharged process gas, for example, is around 40,000 Nm³ per hour. In this example, the amount of water absorbed by the process gas in the industrial plant can be around 800 kg per hour. By branching off a portion of the process gas, for example 10% of the volume flow of the discharged process gas, tests have shown that the average humidity of the process gas involved in the drying process in the industrial plant can be reduced to around 17 g per kg of dry air under favorable atmospheric conditions at 0° C. outside temperature and 30% relative humidity. It has been shown that by branching off a portion of the process gas, the humidity returned to the industrial plant can be reduced and this also offers an energy advantage for the drying process. The numerical data are only given as an example to illustrate the idea of the invention.

FIG. 1a illustrates, by way of example, a first method, carried out or capable of being carried out by the apparatus of FIG. 1, for treating the process gas S3a discharged from the industrial process S2. The method according to FIG. 1a can also be carried out with apparatuses that deviate from FIG. 1, preferably with apparatuses that are analogous or act analogously to the embodiment according to FIG. 1.

For the purposes of this description of embodiments of the invention, an analogous or analogously-acting structure of an apparatus is understood in particular to mean an apparatus structure which differs in at least one component from the specific example of the figure referred to. This deviation can consist in the replacement of this specific component by a substantially or almost equally effective, preferably at least equally effective element (e.g. replacement of a flap by a valve or controllable blower) and/or in the further development of the specific component by adding, removing and/or modifying individual subcomponents and/or adding further subcomponents to this specific component (e.g. a motor-driven flap could be further developed by adding a sensor, for example for flow, temperature and/or pressure measurement).

The first process gas treatment method S3a has the following method steps:
S21: Discharging the process gas from the industrial process S2;
S41: Branching off a portion of the process gas and discharging the portion into an environment;
S22: Supplying the treated process gas from the main line to the industrial process S2.

The branched-off portion of the process gas is discharged into the environment 32 in method step S32a.

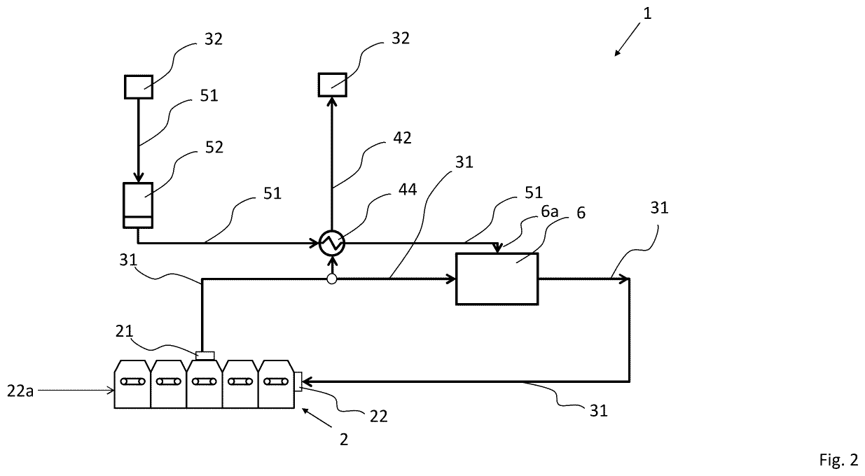

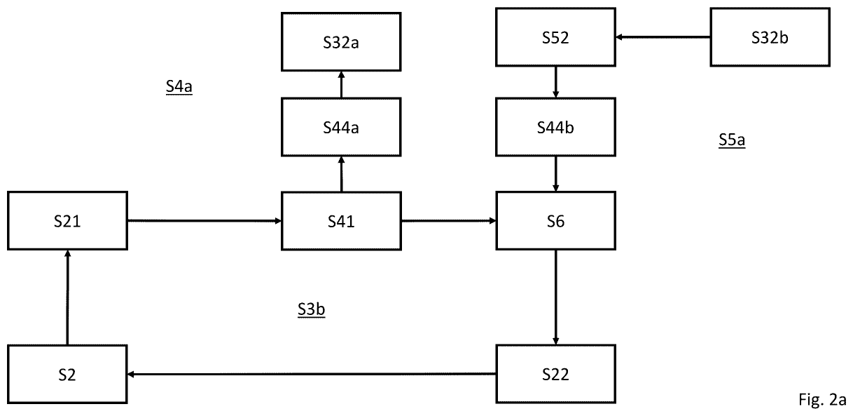

FIG. 2 illustrates a second embodiment of an apparatus for treating process gas from an industrial plant for drying an electrode coating. A heat exchanger 44, which is embodied as a cross-flow heat exchanger, is also arranged in the exhaust gas line 42. The exhaust gas is routed to the heat exchanger 44 after the exhaust gas branch 41. The exhaust gas, which has a temperature of around 120° C. in this example, then flows through the heat exchanger 44, wherein the exhaust gas releases some of its thermal energy. After the exhaust gas has flowed through the heat exchanger 44, the temperature of the exhaust gas drops to around 85° C., for example, when it exits the heat exchanger 44.

A fresh gas line 51 is also connected to a mixer 6 arranged downstream of the exhaust gas branch 41, which in this example is embodied as a flow chamber. Air from the environment 32 is fed into the mixer 6 via the fresh gas line through a secondary inlet 6a. The mixer 6 is also arranged at an interface between the main line 31 and the fresh gas line 51, this interface being arranged upstream of the process gas inlet 22 of the industrial plant 2. After the exhaust gas branch 41, the process gas is fed into the mixer 6. Fresh gas is mixed with the process gas in the mixer 6 and discharged from the mixer 6 into the main line 31. The two gas flows are preferably mixed in the mixer 6 in such a way that the flow is as homogeneous as possible.

A unit for conditioning the fresh gas is provided in the fresh gas line 51, which is designed here as a dehumidifier 52 for adjusting the humidity of the fresh gas, in particular a maximum humidity. The heat exchanger 44 is arranged downstream of the dehumidifier 52. After the fresh gas from the environment 32 is fed into the fresh gas line 51, the fresh gas is fed to the dehumidifier 52 and dehumidified. This cools the fresh gas in the dehumidifier 52 from 30° C. to around 5° C., for example. In the dehumidifier 52, water is condensed out of the fresh gas and discharged from the dehumidifier 52, wherein the moisture content of the fresh gas is reduced from, for example, 20 g/kg to about 5 g/kg. After the dehumidifier 52, the fresh gas is fed to the heat exchanger 44, with the fresh gas flowing through the heat exchanger 44. Fresh gas and exhaust gas preferably flow through the heat exchanger 44 in spatially separate lines and/or channels of the heat exchanger 44 which are in a heat-transferring relationship with one another. The fresh gas absorbs the thermal energy extracted from the exhaust gas and heats up to around 45° C., for example, before it is fed to the main inlet 61 of the mixer 6. Due to the admixture of the fresh gas, the process gas leaving the mixer 6 in this example has an essentially uniformly set temperature of 65° C. and an essentially uniformly set moisture content of 11 g/kg air. Alternatively or additionally, a dehumidifier based on a regenerable hygroscopic working medium could be used, which could reduce or even avoid cooling of the fresh gas.

FIG. 2a illustrates, by way of example, a second method carried out or capable of being carried out by the apparatus of FIG. 2 for treating the process gas S3b discharged from the industrial process S2, a first exhaust gas treatment method S4a and a first fresh gas treatment method S5a. The method according to FIG. 2a can also be carried out with apparatuses that deviate from FIG. 2, preferably with apparatuses that are analogous or act analogously to the embodiment according to FIG. 2.

In the second process gas treatment method S3b, method step S6 is carried out after method step S41 in addition to S3a, wherein the fresh gas from the fresh gas treatment method S5a is mixed with the process gas in mixer 6. After method step S6, the treated process gas is fed to industrial process S2 in method step S22.

The first exhaust gas treatment method S4a has the following method steps:
S44a: Transferring thermal energy from the exhaust gas to the heat exchanger 44;
S32a: Discharging exhaust gas into the environment 32.

The first fresh gas treatment method S5a has the following method steps:
S32b: Supplying fresh air from the environment into the fresh gas line 51;
S52: Dehumidifying fresh gas;
S44b: Transferring thermal energy from the heat exchanger 44 to the fresh gas.

The additional treatment steps in the first fresh gas treatment method can have a positive effect on the reliability of the apparatus'operation. Tests have shown that the process gas can be tempered to a temperature of 65° C. and a humidity of 11 g per kg of dry air when it enters the industrial plant, even if the ambient air is warm and at the same time humid.

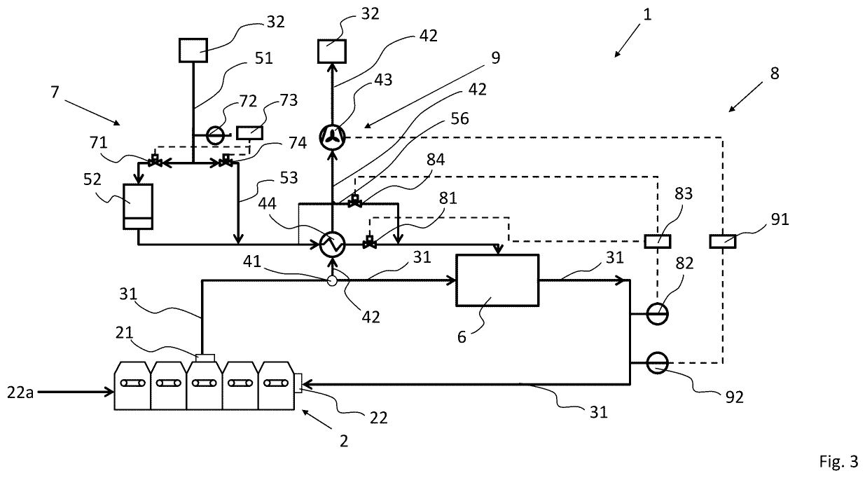

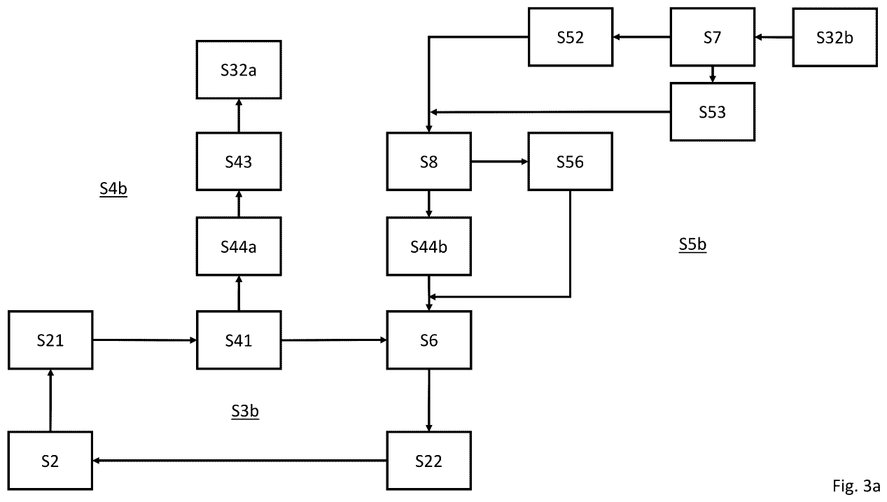

FIG. 3 illustrates a third embodiment of an apparatus for treating process gas from an industrial plant for drying an electrode coating. In addition to the second embodiment, the apparatus has a first bypass line 53 and a first adjuster 7, which can adjust a respective volume flow through the first bypass line 56 and/or through the dehumidifier 52. At least part of the fresh gas which is fed to the dehumidifier 52 is routed past the dehumidifier 52 parallel to the fresh gas line 51 or can be routed past the dehumidifier 52. The first adjuster 7 further comprises a first flap system comprising a first flap 71 and a further first flap 74, wherein the first flap 71 and/or the further first flap 74 can adjust the flow to the dehumidifier and/or in the first bypass line 53. A first humidity sensor 72 is arranged upstream of the first flap 71 in the fresh gas line 51, so that a humidity of the fresh gas is measured before dehumidification. The data measured by the first humidity sensor 72 can be transmitted to a first control unit 73, which in turn adjusts the first flap 71 and/or the further first flap 74 depending on the measured data. According to the invention, the first control unit 73 for adjusting the first flap system comprises the following control logic:
If the humidity of the fresh gas measured before the dehumidifier 52 falls below a certain value F1, the fresh gas can be dehumidified less and accordingly the first flap 71 is closed, while the further first flap 74 is opened. The volume flow of fresh gas is thus routed around the dehumidifier 52. Preferably, the dehumidifier 52 is also switched down and/or off.
If the humidity of the fresh gas measured before the dehumidifier 52 exceeds a certain value F2, dehumidification of the fresh gas takes place and the further first flap 74 is closed, while the first flap 71 is opened. The volume flow of fresh gas is now routed through the dehumidifier 52. In particular, F1 and/or F2 can be a target or limit value; these form a target humidity interval for the fresh gas. In certain cases, F1 and F2 can be identical, so that it is possible to speak of a target humidity of the fresh gas.

The control logic of the first flap system is not conclusive, so that any flap position can be set for a correspondingly measured humidity. In particular, it is conceivable that a volume flow of fresh gas suitable for setting a desired target humidity is fed to and/or routed past the dehumidifier 52 via intermediate positions of the first flap 71 and/or the further first flap 74.

The first adjuster 7 has the advantage of being able to reduce the humidity of the fresh gas if required and to better adjust a target humidity of the process gas both with hot and simultaneously humid ambient air and with cold and dry ambient air. In particular, the process gas can be dehumidified less, even if the dehumidification performance per volume flow of the dehumidifier 52 remains unchanged, because the volume flow routed through the dehumidifier 52 can be reduced by means of the first adjuster 7.

Downstream of the dehumidifier 52, a second bypass line 56 and a second adjuster 8 are arranged in this example, which can adjust a respective volume flow through the second bypass line 56 and/or through the heat exchanger 44. A portion of the fresh gas that is fed to the heat exchanger 44 is routed past the heat exchanger 44 parallel to the fresh gas line 51. The second adjuster 8 further comprises a second flap system comprising a second flap 81 and a further first flap 84, wherein the second flap 81 and/or the further second flap 84 can adjust the flow to the heat exchanger 44 and/or in the second bypass line 56. A temperature sensor 82 is arranged in the main line 31 downstream of the mixer 6, wherein the temperature sensor 82 can measure a temperature of the process gas admixed with fresh gas. The data measured by the temperature sensor 82 can be transmitted to a second control unit 83, which in turn adjusts the second flap and/or the further second flap 84 depending on the measured data.

According to the invention, the second control unit 83 for adjusting the second flap system comprises the following control logic:
If the temperature of the process gas measured in the main line 31 by the temperature sensor 82 falls below a certain value F3, the fresh gas can be heated less and accordingly the second flap 81 is closed, while the further second flap 84 is opened. The volume flow of fresh gas is thus routed around the heat exchanger 44.
If the temperature of the process gas measured in the main line 31 by the temperature sensor 82 exceeds a certain value F4, the fresh gas is heated up and the further second flap 84 is closed, while the second flap 81 is opened. The volume flow of fresh gas is now routed through the heat exchanger 44. In particular, F3 and/or F4 can be a target or limit value; these form a target temperature interval for the fresh gas. In certain cases, F3 and F4 can be identical, so that it is possible to speak of a target temperature of the fresh gas.

The control logic of the second flap system is also not conclusive, so that any flap position can set for a correspondingly measured temperature. In particular, it is conceivable that a volume flow of fresh gas suitable for setting a desired target humidity is fed to and/or routed past the heat exchanger 44 via intermediate positions of the second flap 81 and/or the further second flap 84.

The second adjuster 8 offers the additional advantage of increasing the total thermal energy transferred to the process gas when the ambient air is cold, for example, and reducing heating-when the ambient air is warmer.

Furthermore, FIG. 3 shows a third adjuster 9 in addition to the second embodiment, which has exhaust gas blower 43 arranged in the exhaust gas line 42, with which a volume flow through the exhaust gas line 42 is adjusted. In addition to the exhaust blower 43, the third adjuster 9 has second humidity sensor 92 and a third control unit 91. The second humidity sensor 92 is connected to the exhaust blower 43 via the third control unit 91. The second humidity sensor is arranged in the main line 31 for measuring the humidity of the process gas. The data from the second humidity sensor 92 is transmitted to the third control unit 91, whereupon the control unit 91 controls the exhaust gas blower 43 to adjust a volume flow through the exhaust gas line 42 depending on the measured humidity. If the humidity measured in the main line exceeds a certain target value, a higher volume flow through the exhaust gas line 42 is set by means of the exhaust gas blower 43, wherein the exhaust gas discharged is in turn compensated by a higher volume flow of fresh gas. In particular, the control units can communicate with at least one computer unit that can evaluate the measured data and/or monitor the air parameters. For example, the control units can be part of a central computer. In particular, the computer unit and/or central computer can carry out and further optimize the evaluations using “big data” and/or artificial intelligence.

FIG. 3a illustrates, by way of example, a further method carried out or capable of being carried out by the apparatus of FIG. 3 for treating the process gas S3b discharged from the industrial process S2, a second exhaust gas treatment method S4b and a second fresh gas treatment method S5b. The method according to FIG. 3a can also be carried out with apparatuses that deviate from FIG. 3, preferably with apparatuses that are analogous or act analogously to the embodiment according to FIG. 3.

In the second exhaust gas treatment method S4b, method step S43 takes place after method step S44a in addition to S4a, wherein the exhaust gas is fed to the exhaust gas blower 43, in which the rotational speed is adjusted to set a volume flow. After method step S43, the treated process gas is discharged into the environment 32 in method step S32a.

The second fresh gas treatment process S5b has the following method steps:
S32b: Supplying fresh air from the environment into the fresh gas line 51;
S7: Adjusting a volume flow by means of the first adjuster 7 to the dehumidifier 52 and/or through the first bypass line 53;
S52: Optionally dehumidifying fresh gas by opening or closing the first flap 71;
S53: Optionally routing fresh gas in the first bypass line 53 to bypass dehumidification in step S52 by opening or closing the further first flap 74;
S8: Adjusting a volume flow by means of the second adjuster 8 to the heat exchanger 44 and/or through the second bypass line 56;
S44b: Optionally transferring thermal energy from the heat exchanger 44 to the fresh gas by opening or closing the second flap 81;
S56: Optionally routing fresh gas in the second bypass line 56 for bypassing the method step S44b by opening or closing the further second flap 84, wherein the fresh gas is heated;

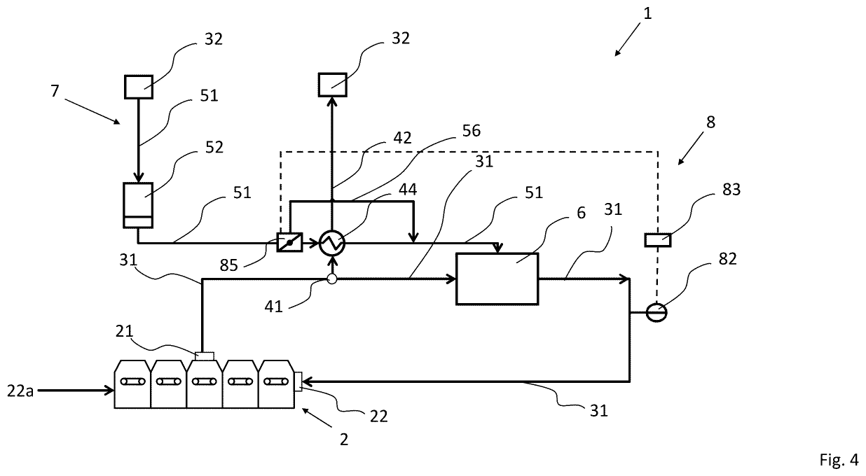

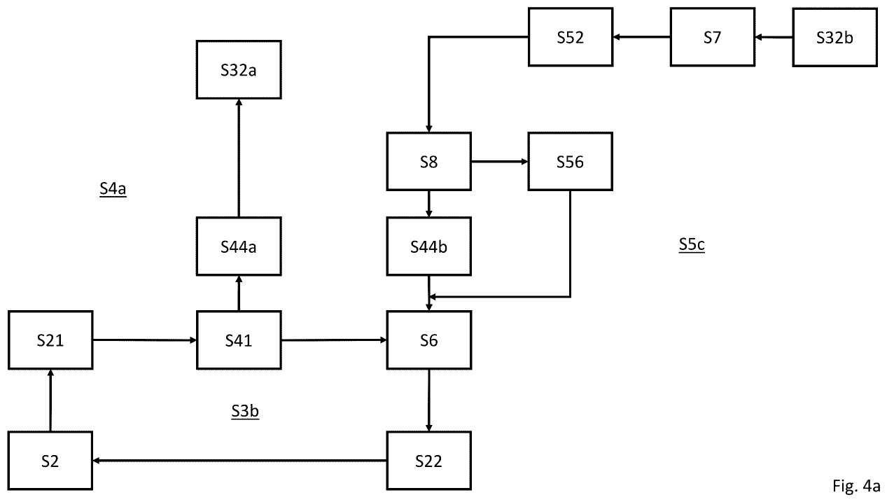

FIG. 4 shows a fourth embodiment of the apparatus according to the invention, wherein the fresh gas in the fresh gas line 51 flows through the dehumidifier 52 after being introduced from the environment 32 and is then routed to the second adjuster 8. The second adjuster 8 comprises a control flap 85 which adjusts a respective volume flow through the second bypass line 56 and through the heat exchanger 44. The control flap 85 is connected to the temperature sensor 82 in the main line 31 via the second control unit 83, wherein the control flap 85 is adjusted by the second control unit 83 depending on the measured temperature of the temperature sensor 82. In this embodiment, the fresh gas can first be dehumidified before it is fed in the fresh gas line 51 to the heat exchanger 44, in which the temperature of the fresh gas is set.

FIG. 4a illustrates a further exemplary method carried out or capable of being carried out by the apparatus of FIG. 4 for treating the process gas S3b discharged from the industrial process S2, the first exhaust gas treatment method S4a and a third fresh gas treatment method S5c. The method according to FIG. 4a can also be carried out with apparatuses that deviate from FIG. 4, preferably with apparatuses that are analogous or act analogously to the embodiment according to FIG. 4.

The third fresh gas treatment method S5c has the following method steps:
S32b: Supplying fresh air from the environment 32 into the fresh gas line 51;
S7: Adjusting a volume flow by means of the first adjuster 7 to the dehumidifier 52 and/or through the first bypass line 53;
S52: Dehumidifying fresh gas;
S8: Adjusting a volume flow by means of the control flap 85 to the heat exchanger and/or through the second bypass line 56;
S44b: Optionally transferring thermal energy from the heat exchanger 44 to the fresh gas by means of the control flap 85;
S56: Optionally routing fresh gas in the second bypass line 56 to bypass the method step S44b by means of the control flap 85, wherein the fresh gas is heated.

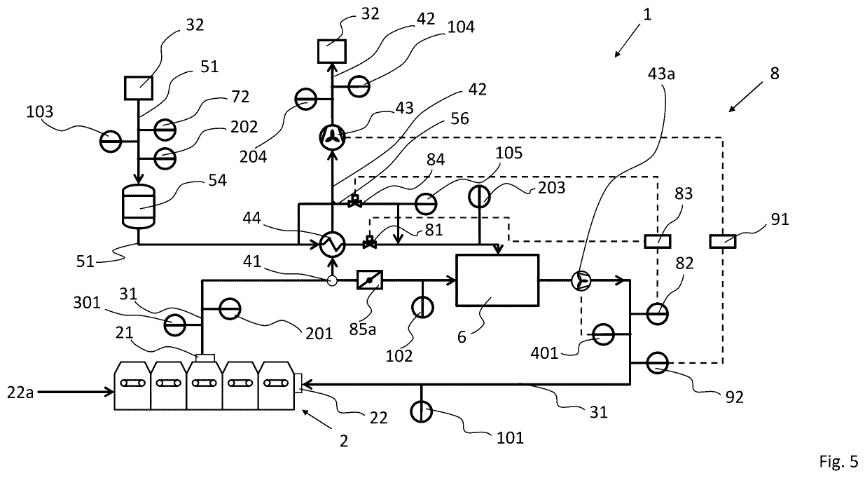

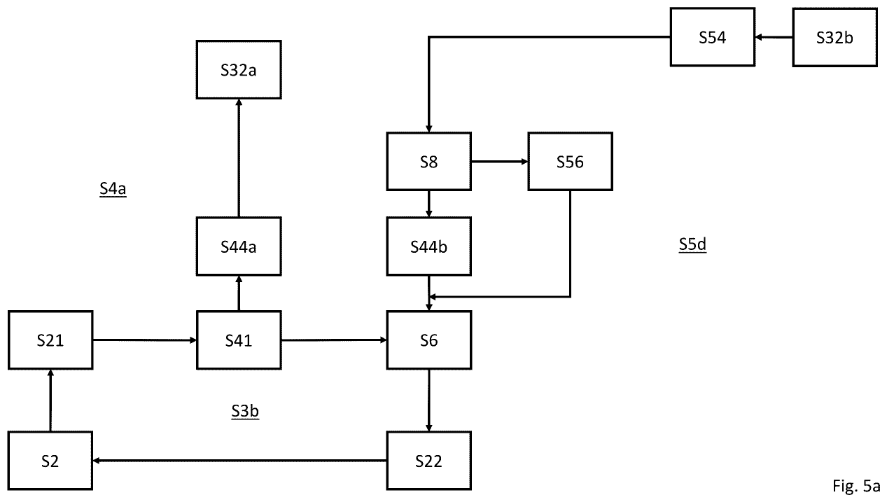

FIG. 5 shows a fifth embodiment of the apparatus according to the invention, wherein the fresh gas in the fresh gas line 51 flows through a HEPA filter 54 after being introduced from the environment 32 and is then routed to the second adjuster 8. In contrast to FIGS. 2 to 4, no dehumidifier 52 is provided in the fresh gas line before the fresh gas is fed to the heat exchanger 44. Preferably, such an embodiment can be used where a comparatively low average ambient humidity is to be expected. After being introduced from the environment 32, the fresh gas is fed to a filter 54, which is designed here as a high-efficiency particulate air (HEPA) filter. The filter 54 optionally has at least one pressure sensor—not shown here—which can be used to determine a pressure difference before and after the filter 54. The determined pressure difference can be used as an indicator for the degree of loading of the filter 54 to indicate an imminent replacement. After the filter 54, the fresh gas is fed to the heat exchanger 44, wherein a portion of the fresh gas can be routed past the heat exchanger 44 into the second bypass line 56 by means of a second adjuster 8, wherein the portion routed past is therefore not heated by the heat exchanger 44. The second adjuster 8 adjusts a respective volume flow, for example by means of flaps (second flap 81 and/or further second flap 84) through the second bypass line 56 and/or through the heat exchanger 44.

A flap 85a is arranged in the main line 31, which can adjust the volume flow after the exhaust gas branch 41 so that no process gas is fed to the mixer 6, i.e. no process gas is fed back into the industrial plant 2. Instead, preferably only fresh gas is fed through the fresh gas line 51 via the mixer 6 into the main line 31 and then to the industrial plant 2. The flap 85a is preferably designed as a manual flap by way of example, wherein an electric flap is also conceivable.

A further blower 43a is arranged in the main line downstream of the mixer 6 and can both convey the process gas through the main line and introduce fresh gas from the environment through the fresh gas line into the main line.

The apparatus 1 has a system of flow sensors 101 to 105, which are arranged at various locations of the apparatus 1. The flow sensor 103 measures the fresh gas volume flow downstream of the filter 54, which is introduced into the fresh gas line 51 from the environment. A further flow sensor 105 is arranged in the second bypass line 56 and measures the bypass volume flow that is routed past the heat exchanger 44. If the bypass volume flow is subtracted from the latter (from the fresh gas volume flow), the volume flow that flows through the heat exchanger 44 can be determined.

In the main line, the flow sensor 102 is arranged after the exhaust gas branch 41 and can measure the fed-back process gas in the main line. Together with the flow sensor 103, the volume flow fed to the industrial plant can thus be determined by adding the fresh gas volume flow. Optionally, the entire volume flow fed to the industrial plant can also be measured directly using a flow sensor 101.

In the following, the interaction of the sensors is explained using a system of humidity and temperature sensors as an example. In addition, all sensors can be integrated into a network, with the measured data being evaluated in one or more computer units.

In this embodiment, the exhaust gas volume flow is measured by means of a flow sensor 104, wherein the exhaust gas volume flow can be adjusted by means of an exhaust gas blower 43. The exhaust gas blower 43 is adjusted by means of the second humidity sensor 92. If the measured humidity is too high, the capacity of the exhaust gas blower 43 can be increased so that more process gas is branched off as exhaust gas. The process gas blower 43a can use a differential pressure sensor 401 to set the volume flow in the main line unchanged at a constant level. As a result, the fresh gas volume flow can be increased and the process gas humidity in the main line 31 can decrease.

In the main line, the humidity sensor 301 and the temperature sensor 201 can be used to measure the humidity and/or temperature of the process gas to be treated, which is fed from the industrial plant 2 into the main line 31. The ambient air parameters are measured in the fresh gas line using the temperature sensor 202 and the first humidity sensor 72. A computer unit, not shown, can carry out a pre-control on the basis of the detected environmental parameters and cause the exhaust gas blower 43, process gas blower 43a and, by means of the second adjuster 8, the volume flow through the heat exchanger 44 to be adjusted. By means of the temperature sensor 204, the exhaust gas temperature can be measured after flowing through the heat exchanger 44 and, by comparing it with the temperature measured by the temperature sensor 201 and with the volume flow from the flow sensor 104, the heat energy transferred in the heat exchanger 44 can be determined.

FIG. 5a illustrates a further exemplary method carried out or capable of being carried out by the apparatus of FIG. 5 for treating the process gas S3b discharged from the industrial process S2, the first exhaust gas treatment method S4a and a fourth fresh gas treatment method S5d. The method according to FIG. 5a can also be carried out with apparatuses that deviate from FIG. 5, preferably with apparatuses that are analogous or act analogously to the embodiment according to FIG. 5.

The fourth fresh gas treatment method S5d has the following method steps:
S32b: Supplying fresh air from the environment 32 into the fresh gas line 51;
S7: Adjusting a volume flow by means of the first adjuster 7 to the dehumidifier 52 and/or through the first bypass line 53;
S8: Adjusting a volume flow by means of the control flap 85 to the heat exchanger and/or through the second bypass line 56;
S44b: Optionally transferring thermal energy from the heat exchanger 44 to the fresh gas by means of the control flap 85;
S56: Optionally routing fresh gas in the second bypass line 56 to bypass the method step S44b by means of the control flap 85, wherein the fresh gas is heated.

In comparison to the third fresh gas treatment process S5c, the dehumidification of the fresh gas (step S52 in the embodiment according to FIG. 4a) is omitted in the embodiment according to FIG. 5a.

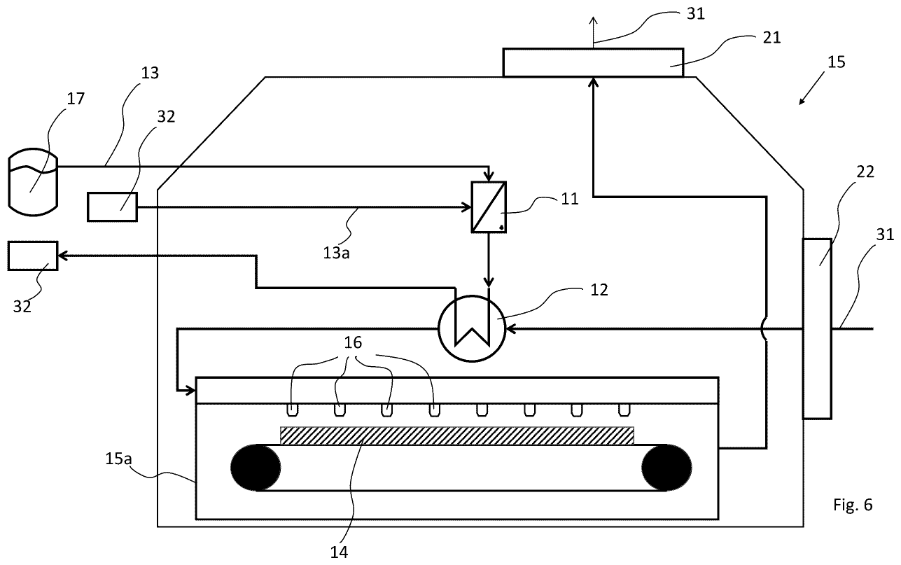

FIG. 6 shows a schematic illustration of a drying module 15 of the industrial plant 2. The treated process gas is routed through the process gas inlet 22 into the industrial plant 2 to a preheating heat exchanger 12, wherein the process gas is additionally tempered for preheating in a further method step as it flows through the preheating heat exchanger 12, wherein the preheating heat exchanger 12 is supplied with additional heat from a heating unit 11. The heating unit 11 is connected to a natural gas source 17 via a natural gas line 13 and is supplied with fresh air from the environment 32 via an air line 13a, wherein natural gas is burned in the heating unit 11 to generate the additional heat. After flowing through the preheating heat exchanger 12, the additionally tempered process gas is brought into contact with a wet coating to be dried in a drying module 15 via air nozzles 16, in which drying module the drying process takes place. After the drying process, the process gas is fed to the process gas outlet 21 of the industrial plant 2 to the main line 31. As described above, the apparatus according to the invention also comprises the objects arranged in the industrial plant. The embodiment of a drying module shown in FIG. 5 is not exhaustive, at least with regard to the actual drying unit (15a), at least in that the drying unit (15a) can also be embodied, for example, as a so-called “floatation dryer” or floating dryer, without this changing the features essential to the invention. (Adjust FIG. 5 accordingly)

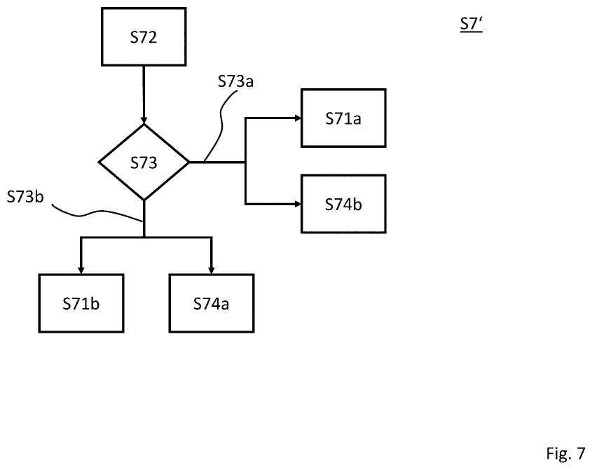

FIG. 7 illustrates a control method of the first adjuster 7′, wherein a respective volume flow to the dehumidifier 52 and/or through the first bypass line 53 is adjusted in the method step S7. The first humidity sensor 72 is used to measure the humidity of the fresh gas before the dehumidifier 52 in accordance with method S72, and the measured data is transmitted to the first control unit 73. The first control unit 73 has a switching method S73, which compares the measured data with a freely selectable value F5. In the case where the measured humidity is greater than the value F5, the method S73a is carried out, in which the first flap 71 is closed according to the method S71a and the further first flap 74 is opened according to the method S74b. The fresh gas is now routed completely through the dehumidifier 52. In the case in which the measured humidity is less than the value F5, the method S73b is carried out in return, in which the respective flap (71, 74) is switched the other way round compared to method S73a. In particular, F5 can be a target or limit value.

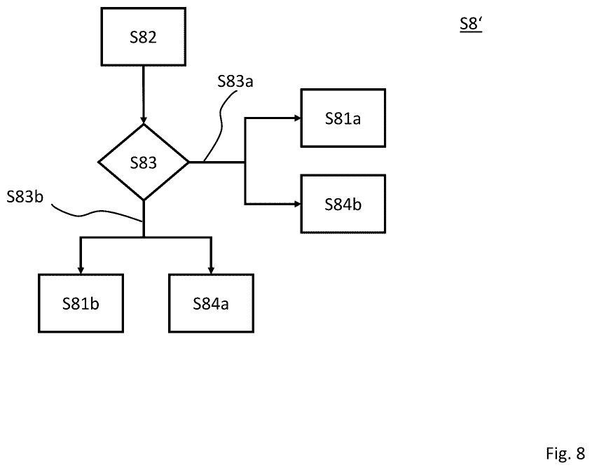

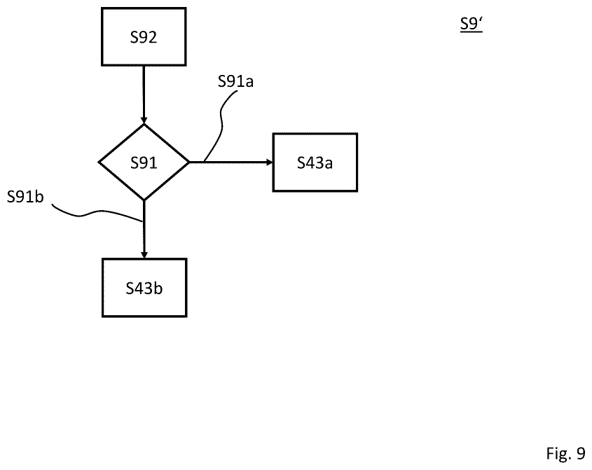

FIG. 8 illustrates a control method of the second adjuster S8′ analogous to FIG. 9, wherein a respective volume flow to the heat exchanger 44 and/or through the second bypass line 56 is adjusted in the method step S8. According to method S82, the temperature of the process gas in the main line 31 downstream of the mixer 6 is measured (see FIG. 3), and the measured data is transmitted to the second control unit 83. With switching method S83, the measured data is also compared with a freely selectable value F6. If the value F6 is exceeded, the method S83b is carried out in which the second flap 81 is closed according to the method S81b and the further second flap 84 is opened according to the method S84a. The fresh gas is now passed completely around the heat exchanger 44 through the second bypass line 56. Analogous to method S83b, the respective flap (81, 84) is switched the other way round when the value falls below F6 in accordance with method S83a. In particular, F6 can be a target or limit value.

FIG. 9 illustrates a control method S9′ of the third adjuster 9, in which the volume flow through the exhaust gas line 42 is adjusted by means of the exhaust gas blower 43 depending on the measured humidity of the process gas. According to method S92, the humidity of the process gas in the main line 31 downstream of the mixer 6 is measured (see FIG. 3), and the measured data is transmitted to the third control unit 91. With the switching method S91, the measured data is compared with a freely selectable value F7. If the value F7 is exceeded, the method S91a is carried out, in which the rotational speed of the exhaust gas blower 91 is increased in accordance with method S43a and a higher volume flow through the exhaust gas line 42 is set. If the value falls below F7, method S91b is carried out again, in which the rotational speed of the exhaust blower 91 is reduced in accordance with method S43b. A lower volume flow through the exhaust gas line 42 is set. In particular, F7 can be a target or limit value.

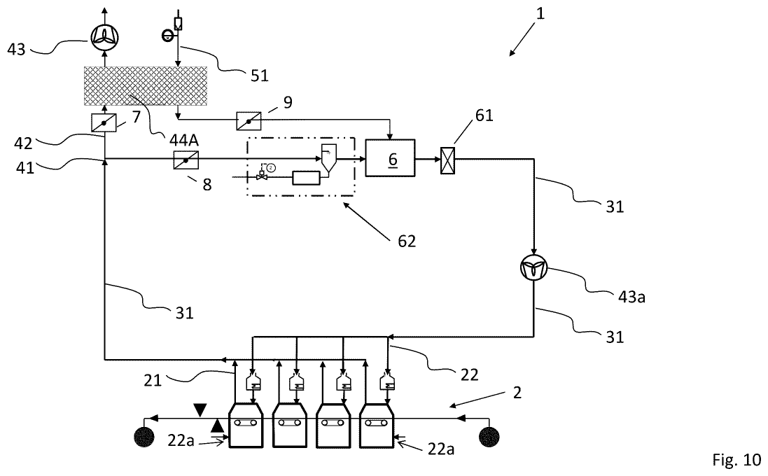

FIG. 10 illustrates a further embodiment of an apparatus for treating process gas from an industrial plant for drying an electrode coating, wherein this embodiment takes up and modifies the embodiment according to FIG. 2. Therefore, only the modification will be described in detail below, while reference is made to the description of FIG. 2 with regard to the unmodified components of the apparatus and its basic mode of operation.

Contrary to the embodiment according to FIG. 2, a heat exchanger configured as a thermal wheel 44A is arranged in the exhaust gas line 42. The thermal wheel 44A is preferably a regenerative rotary heat exchanger in which heat energy can be absorbed in a segment, preferably a circular segment, of a regenerative heat storage element, preferably a circular, toroidal or cylindrical heat accumulator. The segment that absorbs thermal energy is in a first position in relation to a circumferential or peripheral direction of the heat accumulator. By means of a rotational movement, the heat accumulator is moved and/or rotated in one direction of rotation in such a way that the segment which absorbed thermal energy from the exhaust gas at the first position is moved to a second position. In this second position, a fresh gas flows through the said segment of the heat accumulator, absorbing some of the thermal energy stored in this segment and thus heating it up. For this purpose, the fresh gas line 51 is arranged on the thermal wheel 44A at or at least in the vicinity of the second position in such a way that the fresh gas can flow or flows through the part of the heat accumulator located at the second position. In this way, the thermal wheel 44A in the embodiment 10 acts effectively like the heat exchanger 44 of the embodiment example according to FIG. 2. The cycle-related offset between heat energy absorption from the exhaust gas at the first position and heat energy release to the fresh gas at the second position is of secondary importance. It has a slight additional deceleration effect, particularly when starting up from or moving down to the cold state of the apparatus.

For the purposes of the disclosure, a position—be it, for example, the first or second position—should not necessarily be understood to mean only a point or a radial beam through a cross-section of the circular, toroidal or cylindrical thermal accumulator, but rather also an angular region or section, in particular in the sense of a pie slice or angular segment of the circular, toroidal or cylindrical thermal accumulator.

A second modification compared to the embodiment according to FIG. 2 is found in the example according to FIG. 10 in the arrangement of a unit for conditioning the process gas in the main line 31 downstream of the exhaust gas branch 41. In this example, the unit is configured as a humidifier unit 62, with which water, preferably in the form of spray mist and/or steam, can be added to the process gas, preferably before the fresh gas is added in the mixer 6, and thus a humidity of the process gas can be raised to a target value if necessary. In alternative or complementary embodiments, the aforementioned unit may comprise or consist of a dehumidifier, a heating and/or cooling apparatus.

In addition or as an alternative to the unit for conditioning 62 the process gas in the main line 31, it may also be advantageous to provide a unit for conditioning the fresh gas in the fresh gas line 51, as is provided in the embodiment according to FIG. 2, although this variant is not shown in FIG. 10.

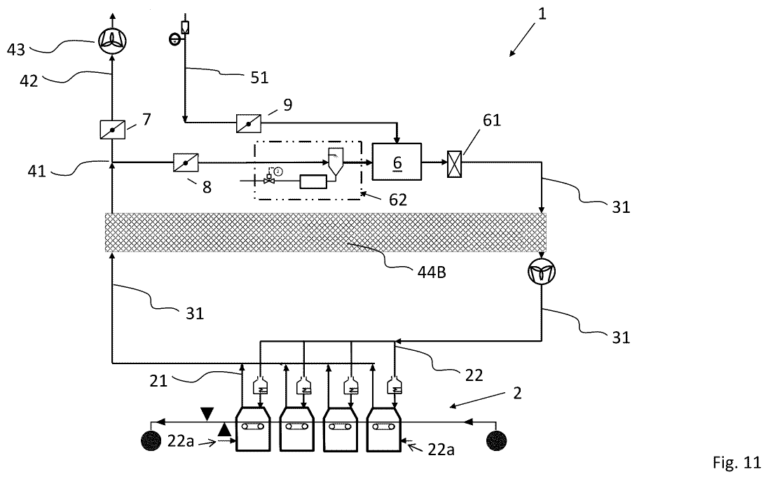

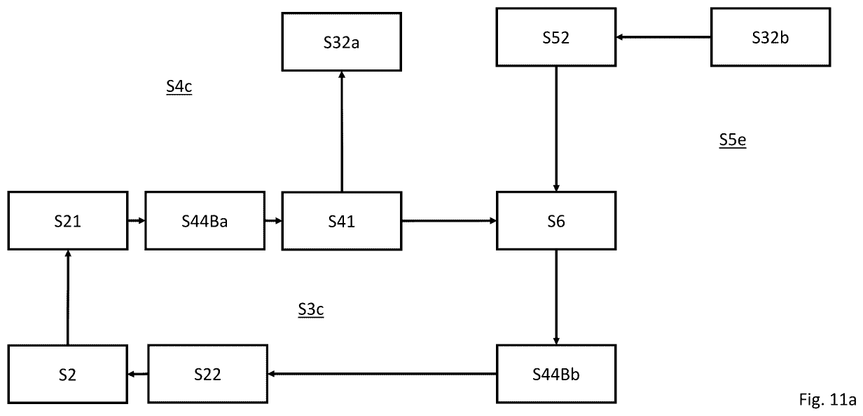

FIG. 11 illustrates a further embodiment of an apparatus for treating process gas from an industrial plant for drying an electrode coating, wherein this embodiment takes up the embodiment according to FIG. 10 and modifies it with regard to the arrangement and integration of the thermal wheel (44B in FIG. 11).

Contrary to the design according to FIG. 10, in the embodiment according to FIG. 11 a heat wheel 44B is integrated into the flow path of the process gas in such a way that heat energy can be extracted from the process gas leaving the industrial plant 2 at the process gas outlet 21 and can be and/or is at least partially transferred to the process gas before it enters the industrial plant 2 at the process gas inlet 22. According to the preferred embodiment according to FIG. 11, the main line 31 leading downstream from the process gas outlet 21 is coupled to the thermal wheel 44B at a first position even before the exhaust gas branch 41 in such a way that (analogous to FIG. 10) heat energy is or can be transferred to a segment of the heat accumulator located at the first position by means of a flow of process gas or other heat transfer from the process gas to the said segment. In the further course of the main line 31, this in turn is coupled downstream of the mixer 6, i.e. preferably after the supply of fresh gas, at a second position to the thermal wheel 44B in such a way that heat energy from a segment of the heat accumulator located at the second position takes place and/or can take place from this segment to the process gas by means of a flow of process gas or other heat transfer. The segment in the second position has been loaded with thermal energy in a previous cycle in which it was in the first position. A heat shift within the process gas is achieved by continuous or discontinuous rotary movement of the heat accumulator of the thermal wheel 44B, wherein in particular the processes in the unit 61, the mixer 6 and the demister 61 can take place at a reduced temperature, while the process gas can be returned to the process gas inlet 21 at a desired, higher temperature level.

FIG. 11a illustrates an exemplary method carried out or capable of being carried out by the apparatus of FIG. 11 for treating the process gas S3c discharged from the industrial process S2, a first exhaust gas treatment method S4c and a first fresh gas treatment method S5e. The method is based on a modified method flow according to FIG. 2a, so that only the deviating method steps are discussed below and reference is otherwise made to the description of FIG. 2a. The method according to FIG. 11a can also be carried out with apparatuses that deviate from FIG. 11, preferably with apparatuses that are analogous or act analogously to the embodiment according to FIG. 11.

In contrast to the process gas treatment method S3a according to FIG. 2a, in the process gas treatment method S3c, heat energy is already removed from the process gas before the method step S41 in step S44Ba. In a step S44Bb following steps S41 and S6 of the process gas treatment method S3c, at least a portion of the thermal energy removed from the process gas in step S44Ba is returned to the process gas before it is fed to the industrial process S2 in step S22.

Furthermore, in the exemplary method according to FIG. 11a, no heat energy is extracted from the exhaust gas in the exhaust gas treatment method S4c, as is provided for in step S44a in the exhaust gas treatment method S4a according to FIG. 2a.

Also, in the fresh gas treatment method S5e according to FIG. 11a, the fresh gas is not subjected to a supply of thermal energy downstream of the conditioning step, in particular the dehumidification step S52, as is provided in step S44b in the fresh gas treatment method S5a according to FIG. 2a.

In particular, no thermal energy extracted from the exhaust gas is transferred to the fresh gas in the method according to FIG. 11a.

The modified heat transfer and/or the shift of thermal energy between sectional and/or process-phase partial flows of the process gas that occurs or results via steps S44Ba and S44Bb can result in a simplification of the other method steps, in particular S41 and/or S6 and/or the requirements for step S52.

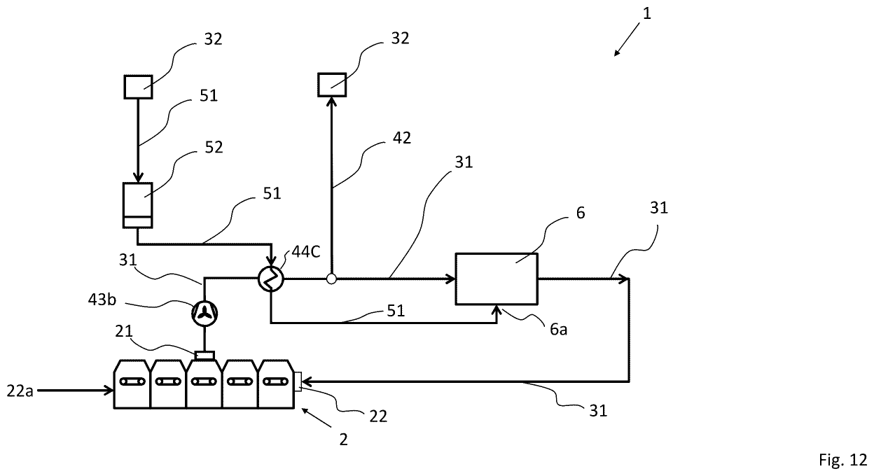

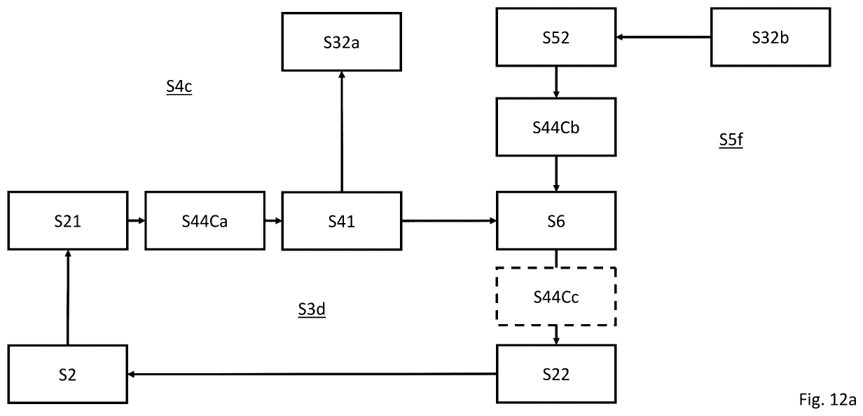

FIG. 12 illustrates a further embodiment of an apparatus for treating process gas from an industrial plant for drying an electrode coating, wherein this embodiment takes up and modifies the embodiment according to FIG. 2. Therefore, only the modification will be described in detail below, while reference is made to the description of FIG. 2 with regard to the unmodified components of the apparatus and its basic mode of operation.

In a first modification, a process gas blower 43b is arranged downstream of the process gas outlet 21 of the industrial plant 2, but upstream of the exhaust gas branch 41, in contrast to the embodiment according to FIG. 2. As a result, all components through which process gas flows but which are arranged downstream of the process gas blower 43b, in particular the exhaust gas branch 41 and the mixer 6, are operated on the pressure side, i.e. the process gas is supplied to these components at an overpressure, whereas in the embodiment according to FIG. 2, the process gas is drawn through these components by means of the process gas blower 43a. The modified design according to FIG. 12 makes it possible to advantageously dispense with an exhaust gas blower 43, as the process gas enters the exhaust gas branch 41 at increased pressure and continues to flow in both outflow directions—into the exhaust gas line 42 and into the continuing part of the main line 31, in particular the part leading to the mixer 6. By creating a flow-induced negative pressure at the secondary inlet 6a of the mixer 6, it is also possible to ensure that fresh gas enters the mixer 6 via the fresh gas line 51 in order to be mixed with the process gas.

For further modification, the design according to FIG. 12 takes up the idea of extracting thermal energy from the process gas even before the exhaust gas branch 41 in the heat exchanger and/or thermal wheel 44B from the design according to FIG. 11. Deviating from this, however, the thermal energy is again transferred to the fresh gas in the fresh gas line upstream of the mixer 6. In the example according to FIG. 12, this is achieved by the heat exchanger 44C, in particular a first channel of the heat exchanger 44C, being integrated in the main line 31 downstream of the process gas outlet 21, but upstream of the exhaust gas branch 41, through which the process gas leaving the industrial plant 2 at an elevated temperature flows or can flow.

The design according to FIG. 12 is particularly advantageous if a secondary use of thermal energy extracted and/or extractable from the industrial plant 2 is or appears to be more favorable than a pure use of heat within the apparatus. It is in fact possible to provide a second extraction channel on the heat exchanger 44C, parallel and/or sequential to a fresh gas channel, for the flow of a heat transfer fluid. By means of the heat transfer fluid, a portion of the thermal energy extracted from the process gas can then be transferred from the apparatus to a secondary process and/or secondary process apparatus.

FIG. 12a illustrates an exemplary method carried out or capable of being carried out by the apparatus of FIG. 12 for treating the process gas S3d discharged from the industrial process S2, a further exhaust gas treatment method S4c and a further fresh gas treatment method S5f. Like the method according to FIG. 11a, the method is also based on a modified method flow according to FIG. 2a, so that only the deviating method steps are discussed below and reference is otherwise made to the description of FIG. 2a. The method according to FIG. 12a can also be carried out with apparatuses that deviate from FIG. 12, preferably with apparatuses that are analogous or act analogously to the embodiment according to FIG. 12.

In contrast to the process gas treatment method S3a according to FIG. 2a, in the process gas treatment method S3d, heat energy is already removed from the process gas before the method step S41 in step S44Ca.

In contrast to the fresh gas treatment method S5e of FIG. 11a, in the fresh gas treatment method S5f of FIG. 12a at least part of the thermal energy removed from the process gas in step S44Ca of the process gas treatment method S3d is transferred to the fresh gas in step S44Cb. Step S44Cb is preferably provided downstream of the conditioning step, in particular the dehumidification step S52 in the fresh gas treatment method S5f of FIG. 12a.

Excess heat energy resulting from this heat transfer between steps S44Ca and S44Cb can be supplied or provided to a secondary process using a method according to FIG. 12a. Alternatively or additionally, this excess thermal energy can also be at least partially supplied to the process gas downstream of the mixing of fresh gas and process gas in step S6 in an optional step S44Cc (shown dashed in FIG. 12a).

The invention is not limited to the embodiments disclosed in the previous examples. Rather, the person skilled in the art obtains further alternative embodiments of the invention covered by the scope of protection by transferring or combining individual features, in particular arrangements or designs of components (e.g., heat exchangers/heat transferors, blowers, mixers and/or units for conditioning fresh gas and/or process gas) from individual embodiments shown in the figures and described in detail.

The scope of protection of the invention is defined by the appended claims. The person skilled in the art will be able to recognize further embodiments of an apparatus according to the invention and a method according to the invention, which are based on modifications and/or combinations of features of the embodiments described above. In particular, for example, the control units can be connected to each other so that the adjustment of the respective adjusters takes place as a function of the other adjusters and, if necessary, the respective adjusting method is optimized.

1. Apparatus for treating process gas from an industrial plant, comprising:
a main line, a first end of the main line being connected to a process gas outlet of the industrial plant for discharging process gas to be treated from the industrial plant and a second end of the main line being connected to a process gas inlet of the industrial plant for supplying the treated process gas into the industrial plant;
an exhaust gas branch for branching off a portion of the process gas from the main line into an exhaust gas line, via which a portion of the process gas is thus dischargeable into an environment in the form of exhaust gas;
a fresh gas line arranged downstream of the exhaust gas branch, via which fresh gas is suppliable to the main line, wherein the fresh gas is air from an environment;
a unit for conditioning the fresh gas, wherein a gas parameter of the fresh gas, in particular a humidity, is adjustable, wherein a gas parameter of the process gas, in particular a temperature and/or a humidity, is adjustable by means of the admixture of the fresh gas;
a first bypass line, through which the fresh gas is conducted past the unit for conditioning the fresh gas; and
a first adjuster, wherein the first adjuster adjusts a respective volume flow in the first bypass line and/or through the unit.

2. The apparatus of claim 1, comprising
a mixer for mixing fresh gas from the fresh gas line with the process gas associated with the main line, the mixer being arranged upstream of the process gas inlet of the industrial plant.

3. (canceled)

4. (canceled)

5. The apparatus of claim 1, comprising
further comprising a heat exchanger for adjusting a gas parameter of the fresh gas, in particular a temperature, wherein a gas parameter of the process gas, in particular a temperature and/or humidity, is adjustable by means of the admixture of the fresh gas.

6. The apparatus of claim 1, comprising at least one of:
a second bypass line, through which fresh gas is conducted past the heat exchanger; and/or
a second adjuster, wherein the second adjuster adjusts a respective volume flow in the second bypass line and/or through the heat exchanger.

7. The apparatus of claim 1, wherein a heat exchanger is provided for extracting thermal energy from the exhaust gas, wherein at least a portion of the extracted thermal energy is transferable to the fresh gas in the fresh gas line and/or to the process gas in the main line downstream of the exhaust gas branch.

8. The apparatus of claim 1, comprising a third adjuster for adjusting a volume flow in the exhaust gas line, in particular an exhaust gas blower associated with the exhaust gas line and/or an exhaust gas flap, preferably a controllable and/or variable exhaust gas flap, wherein a gas parameter of the process gas, in particular a humidity, is adjustable as a function of the volume flow adjusted in the exhaust gas line.

9. A method of treating process gas discharged from an industrial process, the method comprising the following method steps:
discharging the process gas to be treated from the industrial process into a main line
supplying the treated process gas from the main line to the industrial process;
branching of a portion of the process gas at an exhaust gas branch from the main line into an exhaust gas line, via which a portion of the process gas is discharged into an environment in the form of exhaust gas;
supplying fresh gas into the main line via a fresh gas line which opens into the main line downstream of the exhaust gas branch, the fresh gas being air from an environment;
conditioning the fresh gas in a unit for conditioning the fresh gas, wherein a gas parameter of the fresh gas, in particular a humidity, is adjusted, wherein a gas parameter of the process gas, in particular a temperature and/or a humidity, is adjusted by means of the admixture of the fresh gas;
conducting a portion of the fresh gas into a first bypass line past the unit for conditioning the fresh gas; and
adjusting a respective volume flow in the first bypass line and/or through the unit by means of a first adjuster.

10. The method of claim 9,
wherein the fresh gas supplied compensates for the exhaust gas discharged.

11. The method of claim 9 wherein the fresh gas is mixed with the process gas, in particular in a mixer, the respective gas streams being mixed with each other before treated process gas is supplied to the industrial process.

12. (canceled)

13. The method of claim 9,
wherein the first adjuster adjusts the respective volume flow as a function of a gas parameter, in particular a humidity, which is measured before the fresh gas is conditioned.

14. The method of claim 9, wherein further a gas parameter of the fresh gas, in particular a temperature, is adjusted in a heat exchanger before it is supplied into the main line,
wherein a gas parameter of the process gas, in particular a temperature and/or a humidity, is adjusted by means of the admixture of the fresh gas.

15. The method of claim 9, wherein further a portion of the fresh gas is conducted into a second bypass line past a heat exchanger for heating the fresh gas;
a respective volume flow through the heat exchanger and/or through the second bypass line is adjusted by means of a second adjuster, wherein the second adjuster adjusts the respective volume flow as a function of a gas parameter of the process gas, in particular a temperature.

16. The method of claim 9, wherein further thermal energy is extracted from the exhaust gas conducted through the exhaust gas line in a heat exchanger, at least a portion of the thermal energy extracted from the exhaust gas being transferred to the fresh gas in the fresh gas line and/or process gas in the main line.

17. The method of claim 9, wherein a branched-off volume flow in the exhaust gas line is adjusted by means of a third adjuster, in particular an exhaust gas blower associated with the exhaust gas line,
wherein a gas parameter of the process gas, in particular a humidity, is adjusted as a function of the volume flow adjusted in the exhaust gas line.

18. The method of claim 9, wherein, at an end of operation of the process gas treatment, the following steps are performed:
branching of a portion of the process gas at an exhaust gas branch from the main line into an exhaust gas line, via which a portion of the process gas is discharged into an environment in the form of exhaust gas,
wherein more than 50% of the process gas is converted as an exhaust gas volume flow into the exhaust gas line;
supplying fresh gas, preferably air from the environment, via the fresh gas line arranged downstream of the exhaust gas branch into the main line, wherein a volume flow of the supplied fresh gas preferably corresponds to the exhaust gas volume flow.

19. The method of claim 9, wherein the treated process gas is further tempered with additional heat in a further method step before a material to be dried is acted upon by the process gas.

20. (canceled)

21. A system comprising an industrial plant, in particular a dryer, preferably a dryer of a manufacturing plant for the production of electrodes and/or separators, in particular for secondary batteries or fuel cells, and further comprising the apparatus of claim 1.
